(19) United States
(12) Patent Application Publication
(10) Pub. No.: US 2007/0019566 A1
(43) Pub. Date: Jan. 25, 2007

(54) Receiver apparatus and data distribution method

(75) Inventors: Shigeru Sawada, Hirakata-City (JP); Yoshikazu Kita, Yao-City (JP); Norio Fujino, Hirakata-City (JP); Masashi Fujita, Osaka-City (JP)

Correspondence Address: NDQ&M WATCHSTONE LLP, 1300 EYE STREET, NW, 400 EAST TOWER, WASHINGTON, DC, 20005, US

(73) Assignee: Sanyo Electric Co., Ltd., Moriguchi-shi (JP)

(21) Appl. No.: 11/490,165

(22) Filed: Jul. 21, 2006

(30) Foreign Application Priority Data
Jul. 22, 2005 (JP) P2005-212868

(51) Int. Cl. H04J 1/16

(52) U.S. Cl. 370/252; 370/465

(57) ABSTRACT

A receiver apparatus which receives streaming data transmitted from a distribution server via a network, includes: a comparison section configured to compare a time when a re-transmission process of the received streaming data is estimated to be completed with a time when an error correction process of the received streaming data is estimated to be started, when the error correction process can not be applied to the streaming data; and a re-transmission request section configured to send the distribution server a first re-transmission request for requesting that the streaming data be re-transmitted, when it is determined that the time when the re-transmission process is estimated to be completed is going to be earlier than the time when the error correction process is estimated to be started.

### CROSS REFERENCE TO RELATED APPLICATION

This application is based upon and claims the benefit of priority from the prior Japanese Patent Application No. P2005-212868, filed on Jul. 22, 2005; the entire contents of which are incorporated herein by reference.

### BACKGROUND OF THE INVENTION

1. Field of the Invention

The present invention relates to a receiver apparatus and a method which receives streaming data transmitted from a distribution server via a network.

2. Description of the Prior Art

A streaming data distribution system has been known heretofore. In the case of the streaming data distribution system, a distribution server is configured to transmit streaming data to a receiver apparatus (a client terminal) via a network, such as the Internet, by use of UDP (User Datagram Protocol).

To be more specific, the distribution server is configured to divide contents into a plurality of streaming data, and to transmit the divided streaming data by the frame.

In the streaming data distribution system, reception errors sometimes occur due to packet loss or the like, depending on the status of the network.

Receiver apparatuses of the following type have been known as countermeasures for such reception errors. These receiver apparatuses are configured to reconstruct streaming data, in which a reception error has occurred, by performing an error correction process on the streaming data by use of an error correction process such as an FEC (Forward Error Correction) process function.

Descriptions will be provided for an example of an operation of receiver apparatuses of such a type by referring to FIG. 1. An example of FIG. 1 shows an operation of the receiver apparatuses for each frame, the receiver apparatuses is configured to repeat step S501 to S505 until receiving the whole contents.

As shown in FIG. 1, a receiver apparatus performs a reception process on streaming data, which have been transmitted from a distribution server via a network, in step S501.

In this respect, the receiver apparatus continues performing the reception process of step S501 until completing receiving an entire frame formed by streaming data (refer to step S502).

Once the receiver apparatus completes receiving the entire frame constituted of the streaming data, the receiver apparatus performs an FEC process on each of FEC blocks of the streaming data constituting the frame, which has been received, in step S503. Thereafter, the receiver apparatus performs a reproduction process on the streaming data in step S504.

In addition, the receiver apparatus requests the distribution server to transmit streaming data constituting the subsequent frame, in step S505.

Besides, receiver apparatuses of the following type have been known as countermeasures for such reception errors. The receiver apparatuses of this type are configured to request the distribution server to re-transmit streaming data, in which a reception error has occurred, by use of a re-transmission process function such as an ARQ (Automatic Repeat Request) process function.

Descriptions will be provided for an example of an operation of receiver apparatuses of such a type by referring to FIG. 2. An example of FIG. 2 shows an operation of the receiver apparatuses for each frame, the receiver apparatuses is configured to repeat step S601 to S606 until receiving the whole contents.

As shown in FIG. 2, a receiver apparatus performs a reception process on streaming data, which have been transmitted from a distribution server via a network, in step S601.

In step S602, the receiver apparatus determines whether or not a reception error has occurred in the streaming data. In a case where the receiver apparatus determines that a reception error has occurred, the operation proceeds to step S602. In a case where the receiver apparatus determines that no reception error has occurred, the operation proceeds to step S603.

In this respect, the receiver apparatus continues performing the process of step S601 or S602 until the receiver apparatus completes receiving an entire frame constituted of the streaming data (refer to step S603).

In a case where the receiver apparatus completes receiving the entire frame constituted of the streaming data, the receiver apparatus performs a reproduction process on the streaming data constituting the frame which has been received, in step S604.

In addition, the receiver apparatus requests the distribution server to transmit streaming data constituting the subsequent frame.

In step S606, the receiver apparatus requests the distribution server to re-transmit streaming data, in which a reception error has occurred.

In a case where a reception error occurs in merely several percent of a frame, receiver apparatuses of the conventional type including the FEC process function are capable of reconstructing the streaming data in which the reception error has occurred.

However, receiver apparatuses of the conventional type are incapable of reconstructing streaming data in which the reception error has occurred, in a case where a reception error, such as a burst error, which is beyond the capability of the FEC process function, has occurred.

In addition, even if receiver apparatuses of the conventional type including the ARQ process function receive streaming data which have been re-transmitted by a distribution server, the reception of the streaming data may be too late for the receiver apparatuses to perform a reproduction process on the streaming data.

### SUMMARY OF THE INVENTION

A first aspect of the present invention is summarized as a receiver apparatus which receives streaming data transmitted from a distribution server via a network, including: a comparison section configured to compare a time when a re-transmission process of the received streaming data is estimated to be completed with a time when an error correction process of the received streaming data is estimated to be started, when the error correction process can not be applied to the streaming data; and a re-transmission request section configured to send the distribution server a first re-transmission request for requesting that the streaming data be re-transmitted, when it is determined that the time when the re-transmission process is estimated to be completed is going to be earlier than the time when the error correction process is estimated to be started.

In the first aspect, the comparison section can be configured to compare the time when the re-transmission process is estimated to be completed with a time when a reproduction process of the streaming data is estimated to be started, when it is determined that the time when the re-transmission process is estimated to be completed is not going to be earlier than the time when the error correction process is estimated to be started, the re-transmission request section can be configured to send the distribution server a second re-transmission request for requesting that the streaming data be re-transmitted, when it is determined that the time when the re-transmission process is estimated to be completed is going to be earlier than the time when the reproduction process is estimated to be started, and the receiver apparatus further comprises a data processor section configured to control to reproduce the streaming data re-transmitted in response to the second re-transmission request without performing the error correction process on the steaming data.

A second aspect of the present invention is summarized as a method for distributing streaming data from a distribution server to a receiver apparatus via a network, including: comparing, at the receiver apparatus, a time when a re-transmission process of the received streaming data is estimated to be completed with a time when an error correction process of the received streaming data is estimated to be started, when the error correction process can not be applied to the streaming data; and sending, at the receiver apparatus, the distribution server a first re-transmission request for requesting that the streaming data be re-transmitted, when it is determined that the time when the re-transmission process is estimated to be completed is going to be earlier than the time when the error correction process is estimated to be started.

### BRIEF DESCRIPTION OF THE DRAWINGS

FIG. 1 is a flowchart showing an operation of a receiver apparatus in a conventional streaming data distribution system.

FIG. 2 is a flowchart showing an operation of another receiver apparatus in the conventional streaming data distribution system.

FIG. 3 is a diagram of an overall configuration of a streaming data distribution system according to a first embodiment of the present invention.

FIG. 4 is a diagram for explaining a reception process, an FEC process and a reproduction process performed by a receiver apparatus in the streaming data distribution system according to the first embodiment of the present invention.

FIG. 5 is a diagram for explaining various types of times used in the streaming data distribution system according to the first embodiment of the present invention.

FIG. 6 is a flowchart showing an operation of the receiver in the streaming data distribution system according to the first embodiment of the present invention.

FIG. 7 is a flowchart showing an operation of the receiver in the streaming data distribution system according to the first embodiment of the present invention.

FIG. 8 is a diagram of an overall configuration of a streaming data distribution system according to a second embodiment of the present invention.

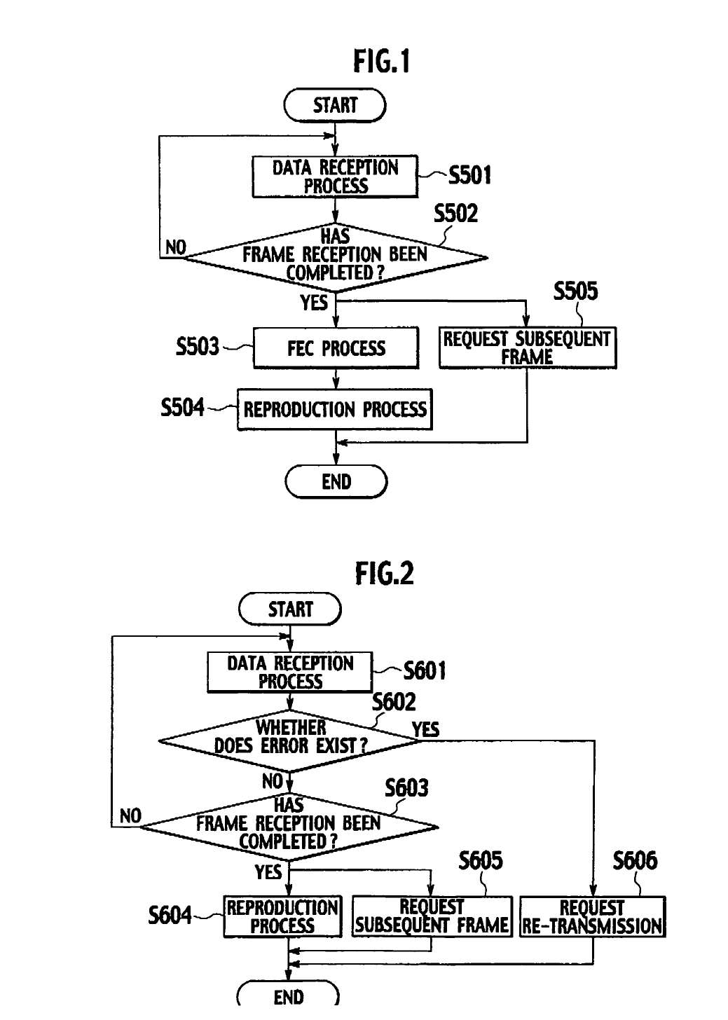

### DESCRIPTION OF THE PREFERRED EMBODIMENT

(Configuration of Streaming Data Distribution System According to First Embodiment of Present Invention)

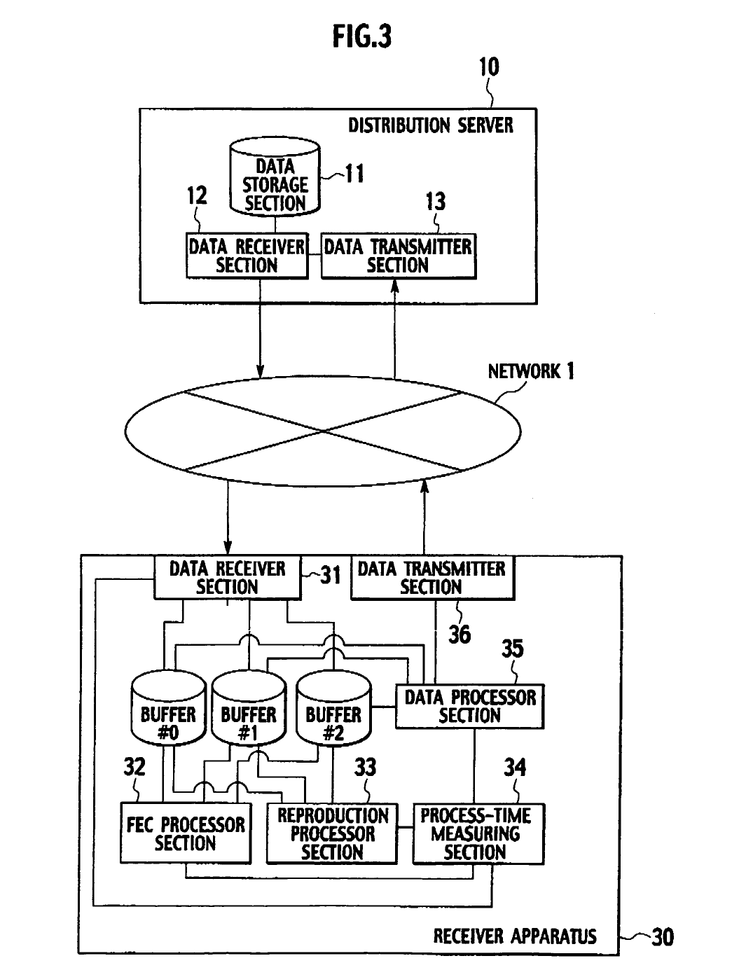

By referring to FIG. 3, descriptions will be provided for a configuration of a streaming data distribution system according to a first embodiment of the present invention.

The streaming data distribution system according to the present embodiment has a configuration in which a distribution server 10 transmits streaming data to a receiver apparatus 30 via a network 1 such as the Internet.

Note that, in the case of this embodiment, streaming data are data (for example, audio data, video data and the like) continuously transmitted therebetween with little delay by use of UDP.

As shown in FIG. 3, the distribution server 10 includes a data storage section 11, a data transmitter section 12 and a data receiver section 13.

The data storage section 11 is configured to store streaming data to be transmitted via the network 1.

The data transmitter section 12 is configured to transmit the streaming data, which are stored in the data storage section 11, to the receiver apparatus 30 via the network 1 by use of UDP at predetermined timings.

In addition, in response to a re-transmission request sent from the receiver apparatus 30, the data transmitter section 12 is configured to re-transmit the streaming data, which correspond to the re-transmission request, to the receiver apparatus 30.

The data receiver apparatus 30 is configured to receive the re-transmission request which has been sent from the receiver apparatus 30, and to thus inform the data transmitter section 12 of the reception of the re-transmission request.

As shown in FIG. 3, the receiver apparatus 30 includes a data receiver section 31, an FEC processor section 32, a reproduction processor section 33, a data processor section 35, a data transmitter section 36, a process-time measuring section 34, and a plurality of buffers #0 to #2.

In the example shown in FIG. 3, the receiver apparatus 30 is configured to include three buffers #0 to #2. However, the number of buffers is not limited to three.

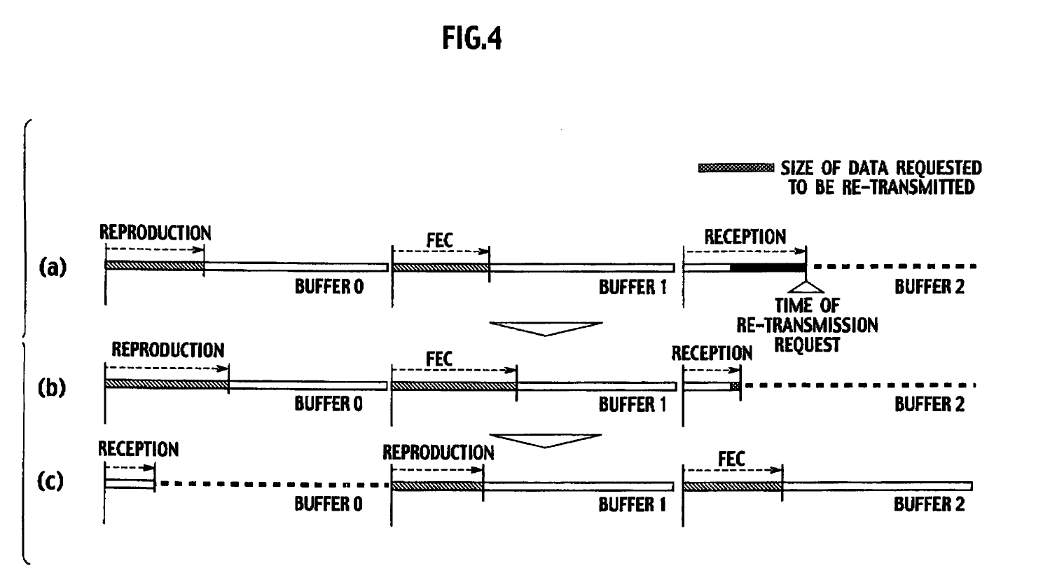

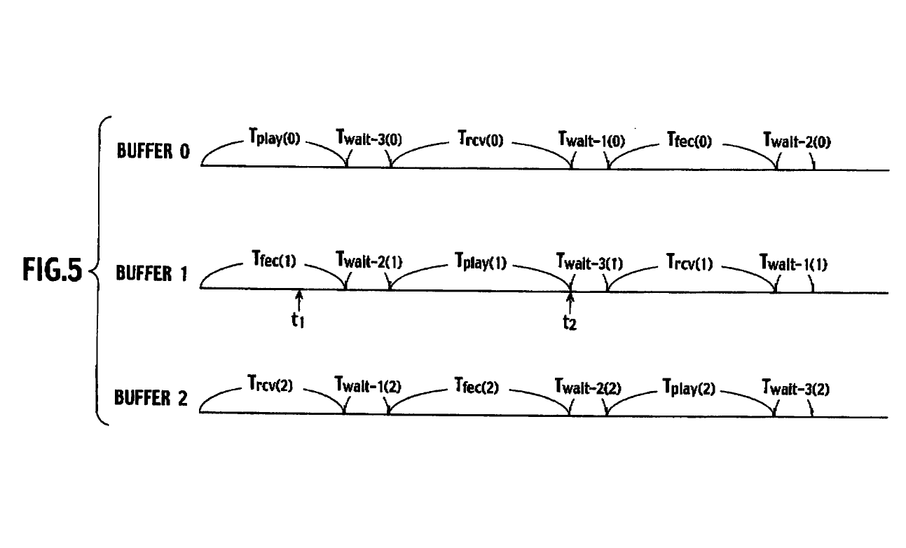

It should be noted that the reception process, the FEC process and the reproduction process are configured to be performed in parallel by the data receiver section 31, the FEC processor section 32 and the reproduction processor section 33, respectively. This configuration will be described below by referring to FIGS. 4(a) to 4(c).

For example, as shown in FIG. 4(a), while the reproduction processor section 33 is playing back streaming data stored in the buffer #0, the FEC processor section 32 is performing an FEC process on streaming data stored in the buffer #1, and the data receiver section 31 is storing received streaming data in the buffer #2.

Subsequently, as shown in FIG. 4(c), the reproduction processor section 33 starts to reproduce the streaming data stored in the buffer #1 once the reproduction processor section 33 completes playing back the streaming data stored in the buffer #0.

As a result, in this case, the FEC processor section 32 starts to perform an FEC process on the streaming data stored in the buffer #2, and the data receiver section 31 starts to store received streaming data in the buffer #0.

In addition, as shown in FIG. 4(a), at a time when the data processor section 35 detects more reception errors than a predetermined number of reception errors while receiving streaming data (“at a time of re-transmission request” in FIG. 4(a)), if the data processor section 35 determines that re-transmission of each packet of streaming data (streaming data corresponding to “a size of data requested to be re-transmitted” in FIG. 4(a)) in which the reception errors are detected is going to be completed before an FEC process is started, the data processor section 35 requests the distribution server 10 to re-transmit the streaming data via the data transmitter section 36.

In other words, as shown in FIG. 4(b), in a case where the data processor section 35 determines through the foregoing calculations that the data receiver section 31 is going to be able to complete storing re-transmitted streaming data before the reproduction processor section 33 completes playing back the streaming data in the buffer #0, the data processor section 35 sends the distribution server 10 the foregoing re-transmission request.

The data receiver section 31 is configured to perform a reception process on the streaming data which have been transmitted from the distribution server 10.

Specifically, the data receiver section 31 is configured to store the received streaming data in each of the buffers #0 to #2 in a predetermined sequence.

The FEC processor section 32 is configured to perform an FEC process on each of FEC blocks of the streaming data which have been stored in the buffers #0 to #2.

Specifically, the FEC processor section 32 is configured as follows.

The FEC processor section 32 extracts FEC blocks of the streaming data from each of the plurality of buffers #0 to #2 in a predetermined sequence, and thus performs an FEC process on the extracted streaming data.

Thereby, the FEC processor section 32 reconstructs streaming data in which a reception error has occurred.

The reproduction processor section 33 is configured to perform a reproduction process on the streaming data stored in the buffers #0 to #2.

Specifically, the reproduction processor section 33 is configured to extract the FEC-processed streaming data from each of the plurality of buffers #0 to #2, and to thus reproduce the extracted streaming data.

Even in a case where no FEC process has been applied to streaming data re-transmitted by the distribution server 10, the reproduction processor section 33 may be configure to reproduce the streaming data.

The process-time measuring section 34 is configured to measure a time (re-transmission process time) “Tᵣₑₜ₍ₙ₎”. The time “Tᵣₑₜ₍ₙ₎” starts when a request for re-transmission of streaming data (a first or a second re-transmission request described below) is sent to the distribution server 10. The time “Tᵣₑₜ₍ₙ₎” ends when storage of the streaming data, which have been re-transmitted by the distribution server 10, in a buffer is completed.

In addition, as shown in FIG. 5, the process-time measuring section 34 is configured to measure a time (a first waiting time) “T_{wait-1(n)}”. The time “T_{wait-1(n)}” starts when the storage of the streaming data, which have been transmitted from the streaming distribution sever 10, in each of the buffers #0 to #2 is completed. The time “T_{wait-1(n)}” ends when an FEC process of the streaming data starts.

Furthermore, as shown in FIG. 5, the process-time measuring section 34 is configured to measure a time (a second waiting time) “T_{wait-2(1)}”. The time “T_{wait-2(n)}” starts when the FEC process of the streaming data, which have been transmitted from the distribution server 10, is completed in each of the buffers #0 to #2. The time “T_{wait-2(n)}” ends when a reproduction process of the streaming data starts.

Furthermore, as shown in FIG. 5, the process-time measuring section 34 is configured to measure a time (a third waiting time) “T_{wait-3(n)}”. The time “T_{wait-3(n)}” starts when the reproduction process of the streaming data, which have been transmitted from the distribution server 10, is completed in each of the buffers #0 to #2. The time “T_{wait-3(n)}” ends when the storage of the streaming data in each of the buffers #0 to #2 starts.

Moreover, as shown in FIG. 5, the process-time measuring section 34 is configured to measure a time (a reception process time) “T_{rcv(n)}” needed for performing a reception process on each frame of streaming data in each of the buffers #0 to #2.

Additionally, as shown in FIG. 5, the process-time measuring section 34 is configured to measure a time (an FEC process time) “T_{fec(n)}” needed for performing an FEC process on each FEC block of streaming data in each of the buffers #0 to #2.

As well, as shown in FIG. 5, the process-time measuring section 34 is configured to measure a time (a reproduction process time) “T_{play(n)}” needed for performing a reproduction process on each frame of streaming data in each of the buffers #0 to #2.

In addition, the process-time measuring section 34 may be configured to measure the foregoing “Tᵣₑₜ₂₍ₙ₎”, “T_{wait-1(n)}”, “T_{wait-2(n)}”, “T_{wait-3(n)}”, “T_{rcv(n)}”, “T_{fec(n)}” and “T_{play(n)}” periodically.

In a case where the data processor section 35 can perform no FEC process (error correction process) on received streaming data, the data processor section 35 is configured to compare a time when a re-transmission process of the streaming data is estimated to be completed with a time when an FEC process (an error correction process) of the streaming data is estimated to be started.

In this respect, “a time when a re-transmission process of the streaming data is estimated to be completed” means a time when storage of the streaming data, which has been re-transmitted by the distribution server 10, in a buffer is estimated to be completed.

Moreover, “a time when an FEC process (an error correction process) of the streaming data is estimated to be started” means a time when the FEC process (the error correction process) of the streaming data by the FEC processor section 32 is estimated to be started.

Specifically, in a case where the data processor section 35 detects reception errors, an amount of which exceeds an amount of feasible error corrections, in streaming data in each FEC block (in other words, in a case where the data processor section 35 detects that reception errors, which exceed the FEC processor section 32's capability of error corrections, have occurred in streaming data in each FEC block), the data processor section 35 is configured to determine whether or not the storage of the streaming data, re-transmitted by the distribution server 10, in a buffer is going to be completed before the FEC processor section 32 starts to perform an FEC process on the streaming data.

More specifically, in a case where the data processor section 35 detects reception errors, an amount of which exceeds an amount of feasible data corrections, in each FEC block of streaming data in the buffer #2, if “T_{wait-1(2)}>Tᵣₑₜ₍₂₎”, the data processor section 35 determines that the storage of the streaming data, re-transmitted by the distribution server 10, in the buffer #2 is going to be completed before the FEC processor section 32 starts to perform an FEC process on the streaming data.

Since, the start of the FEC process in each FEC block of streaming data can be delayed by “T_{wait-2(2)}”, in a case where the data processor section 35 detects reception errors, an amount of which exceeds an amount of feasible data corrections, in each FEC block of streaming data in the buffer #2, if “T_{wait-1(2)}+T_{wait-2(2)}>Tᵣₑₜ₍₂₎”, the data processor section 35 can determine that the storage of the streaming data, re-transmitted by the distribution server 10, in the buffer #2 is going to be completed before the FEC processor section 32 starts to perform an FEC process on the streaming data.

Moreover, in a case where the data processor section 35 determines that a time when the re-transmission process of the streaming data is estimated to be completed is not earlier than a time when an error correction process of the streaming data is estimated to be started, the data processor section 35 may be configured to compare the time when the re-transmission process of the streaming data is estimated to be completed with a time when a reproduction process of the streaming data is estimated to be started.

In this respect, “a time when a reproduction process of the streaming data is estimated to be started” means a time when the reproduction processor section 33 is estimated to start to perform a reproduction process on the streaming data.

In other words, in a case where the data processor section 35 determines that the storage of the streaming data, re-transmitted by the distribution server 10, in a buffer is not going to be completed before the FEC processor section 32 starts to perform the FEC process on the streaming data, the data processor section 35 may be configured to determine whether or not the storage of the streaming data, re-transmitted by the distribution server 10, in the buffer is going to be completed before the reproduction processor section 33 starts to perform a reproduction process on the streaming data.

Specifically, in a case where, “T_{wai-1(1)}=T_{fec(1)}−T_{rcv(2)}=T_{play(0)}−T_{fec(1)}” is assumed, and, as described above, the data processor section 35 determines that the storage of the streaming data, re-transmitted by the distribution server 10, in the buffer #2 is not going to be completed before the FEC processor section 32 starts to perform the FEC process on the streaming data, if “T_{play(0)}+T_{play(1)}−T_{rcv(2)}>Tᵣₑₜ₍₂₎ (that is, T_{play(1)}+T_{wait-1(1)}>Tᵣₑₜ₍₂₎)” is satisfied, the data processor section 35 determines that the storage of the streaming data, re-transmitted by the streaming distribution, in the buffer #2 is going to be completed before the reproduction processor section 33 starts to perform a reproduction process on the streaming data.

Moreover, in a case where, as described above, the data processor section 35 determines that the storage of the streaming data, re-transmitted by the distribution server 10, in the buffer #2 is not going to be completed before the FEC processor section 32 starts to perform the FEC process on the streaming data, if “T_{wait-1(2)}+T_{fec(2)}+T_{wait-2(2)}>Tᵣₑₜ₍₂₎” is satisfied, the data processor section 35 can determine that the storage of the streaming data, re-transmitted by the streaming distribution, in the buffer #2 is going to be completed before the reproduction processor section 33 starts to perform a reproduction process on the streaming data.

Furthermore, in a case where, as described above, the data processor section 35 determines that the storage of the streaming data, re-transmitted by the distribution server 10, in the buffer #2 is not going to be completed before the FEC processor section 32 starts to perform the FEC process on the streaming data, if “time when the reproduction of the streaming data stored in the buffer #1 is estimated to be completed”—“the time when the data processor section 35 determines”>“Tret(2)” is satisfied, the data processor section 35 can determine that the storage of the streaming data, re-transmitted by the distribution server 10, in the buffer #2 is going to be completed before the reproduction processor section 33 starts to perform a reproduction process on the streaming data.

In addition, “time when the reproduction of the streaming data stored in the buffer #1 is estimated to be completed” can be estimated according to information inserted into the streaming data.

And, the data processor section 35 is configured to determine that the streaming data is normal streaming data or the streaming data is streaming data which has been re-transmitted in response to a re-transmission request (the first or the second re-transmission request) sent from the receiver apparatus 30, by storing the range of the streaming data to be re-transmitted in response to the first re-transmission request and the range of the streaming data to be re-transmitted in response to the second re-transmission request.

In a case where it is determined that the time when the re-transmission process of the streaming data is estimated to be completed is earlier than the time when the error correction process of the streaming data is estimated to be started, the data transmitter section 36 is configured to send the distribution server 10 a first re-transmission request for the streaming data to be re-transmitted.

Furthermore, in a case where it is determined that the time when the re-transmission process of the streaming data is estimated to be completed is not earlier than the time when the error correction process of the streaming data is estimated to be started, and in a case where it is determined that the time when the re-transmission process of the streaming data is estimated to be completed is earlier than the time when the reproduction process of the streaming data is estimated to be started, the data transmitter section 36 may be configured to send the distribution server 10 a second re-transmission request for the streaming data to be re-transmitted.

Note that, by use of the first and the second re-transmission requests, the data transmitter section 36 requests the distribution server 10 to re-transmit streaming data which are received by the data receiver section 31 last time, streaming data which are currently expected to be received thereby, and streaming data which are received thereby between the two sets of streaming data.

In the case where, the streaming data, re-transmitted by the distribution server 10 in accordance with the first re-transmission request, is not received by the receiver apparatus 30 before a time when the FEC process on the streaming data starts, due to transmission delay and the like, the FEC processor section 32 is configured to perform the FEC process on the subsequent streaming data without waiting the streaming data.

In the case where, the streaming data, re-transmitted by the distribution server 10 in accordance with the first or second re-transmission request, is not received by the receiver apparatus 30 before a time when the reproduction process on the streaming data starts, due to transmission delay and the like, the reproduction processor section 33 is configured to perform the reproduction process on the subsequent streaming data without waiting the streaming data.

(Operation of Streaming Data Distribution System According to First Embodiment of Present Invention)

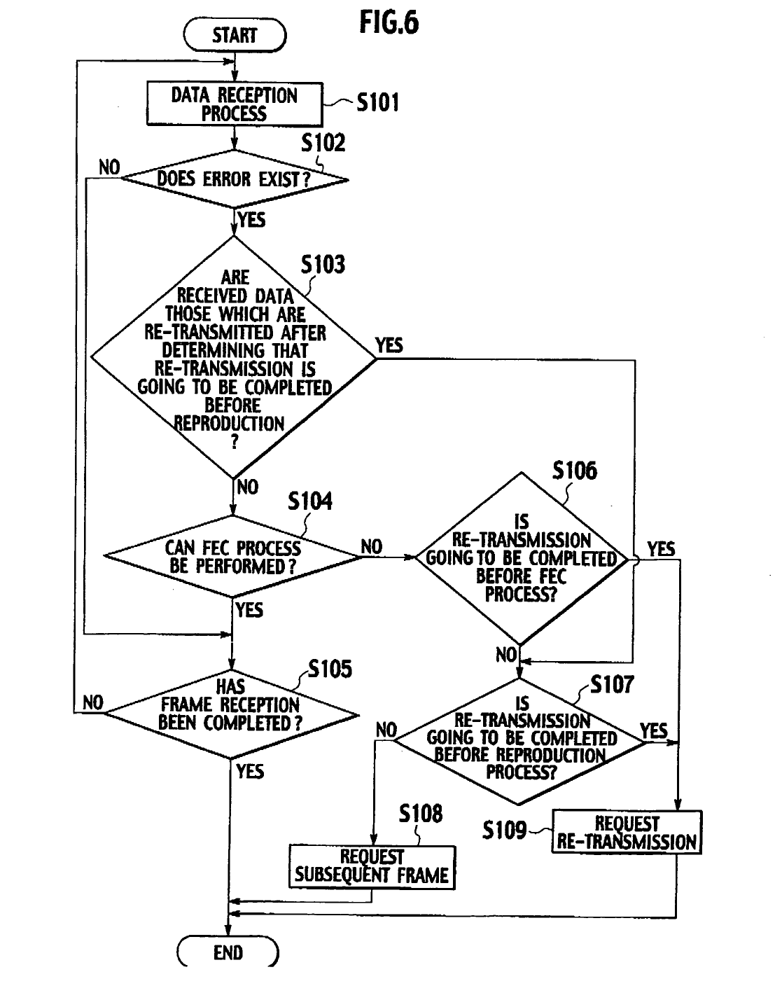

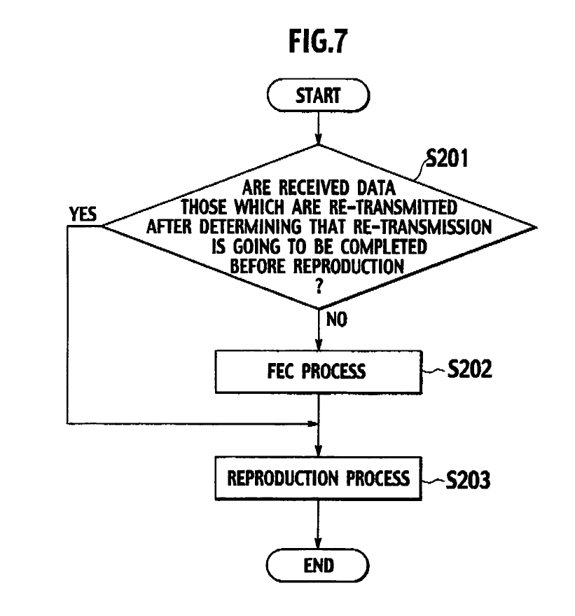

By referring to FIGS. 6 and 7, descriptions will be provided for an operation of the receiver apparatus 30 in the streaming data distribution system according to the first embodiment of the present invention. An example of FIG. 6 shows an operation of the receiver apparatuses for each frame, the receiver apparatuses is configured to repeat step S101 to S109 until receiving the whole contents.

As shown in FIG. 6, in step S101, the data receiver section 31 performs a reception process on streaming data which have been transmitted from the distribution server 10.

Specifically, the data receiver section 31 stores the received streaming data in any one of the buffers #0 to #2 in a predetermined sequence.

In step S102, the data processor section 35 determines whether or not a reception error has occurred in the streaming data stored in one of the buffers.

In a case where the data processor section 35 determines that a reception error has occurred there, the operation proceeds to step S103. In a case where the data processor section 35 determines that no reception error has occurred there, the operation proceeds to step S105.

In step S103, the data processor section 35 determines whether or not the streaming data are those which have been re-transmitted by the distribution server 10, and whether or not the streaming data are those which it has been already determined that are going to be late for the FEC process.

That is, the data processor section 35 determines whether or not the streaming data are those which are re-transmitted after it is determined in step S107, which will be described later, that storage of the re-transmitted streaming data in the buffer is going to be completed before a reproduction process.

In this respect, in the case where the streaming data are those which are re-transmitted after it is determined in step S107 that the storage of the re-transmitted streaming data in the buffer is going to be completed before the reproduction process, the operation proceeds to step S107. In the other case, the operation proceeds to step S104.

In step 104, the data processor section 35 determines whether or not reception errors, an amount of which exceeds an amount of feasible error corrections, are detected in streaming data stored in the buffer. That is, the data processor section 35 determines whether or not the number of detected reception errors is not smaller than a predetermined number.

In a case where it is determined that the number of detected reception errors is not smaller than the predetermined number, the operation proceeds to step S106. In the other case, the operation proceeds to step S105.

Subsequently, the operation repeats the processes from step S101 to step S104 until the receiver 30 completes receiving the entire frame constituted of the streaming data (refer to step S105).

In step S106, the data processor section 35 determines whether or not a re-transmission process of streaming data, on which an FEC process is determined to be unable to be performed in step S104, is going to be completed before the FEC process starts to be applied to the streaming data.

In a case where the re-transmission process of the streaming data is going to be completed before the FEC process starts, the operation proceeds to step S109. In the other case, the operation proceeds to step S107.

In step S107, the data processor section 35 determines whether or not a re-transmission process of the streaming data, which is determined to be late for the time when the FEC process starts in step S108, is going to be completed before a reproduction process of the streaming data starts.

In a case where it is determined that the re-transmission process is going to be completed before the start of the reproduction process, in step S109, the data transmitter section 36 sends the distribution server 10 a request for the streaming data to be re-transmitted.

Here, in a case where it is determined that the time when the re-transmission process on the streaming data is estimated to be completed is earlier than the time when the error correction process on the streaming data is estimated to starts (in a case where “YES” in step S106), the data transmitter section 36 sends the distribution server 10 a first request for the streaming data to be re-transmitted.

Moreover, in a case where it is determined that the time when the re-transmission process on the streaming data is estimated to be completed is not earlier than the time when the error correction process on the streaming data is estimated to starts, and in a case where it is determined that the time when the re-transmission process on the streaming data is estimated to be completed is earlier than the time when the reproduction process on the streaming data is estimated to starts (in a case where “YES” in step S106) (in a case where “YES” in step S107), the data transmitter section 36 sends the distribution server 10 a second request for the streaming data to be re-transmitted.

On the other hand, in a case where it is determined that the re-transmission process is not going to be completed before the start of the reproduction process, in step S108, the data transmitter section 36 gives up the re-transmission process of the streaming data, and sends the distribution server 10 a request for streaming data constituting the subsequent frame to be transmitted.

Next, as shown in FIG. 6, once the receiver apparatus 30 completes receiving the entire frame, in step S201, the data processor section 35 determines whether or not the streaming data are those which the distribution server 10 have re-transmitted, and whether or not the streaming data are those which is already determined to be going to be late for the FEC process.

In other words, the data processor section 35 determines whether or not the streaming data are those which are re-transmitted after it is determined in step S109, which will be described later, that the storage of the streaming data in the buffer is going to be completed before the reproduction process.

In this respect, in the case where the streaming data are those which are re-transmitted after it is determined in step S107 that the storage of the streaming data in the buffer is going to be completed before the reproduction process, the operation proceeds to step S203. In the other case, the operation proceeds to step S202.

In step S202, the FEC processor section 32 performs an FEC process on each frame of the streaming data. Subsequently, in step S203, the reproduction processor section 33 performs a reproduction process on the streaming data on which the FEC processor section 32 has completed performing the FEC process.

(Work and Effect of Streaming Data Distribution System According to this Embodiment)

The case of the streaming data distribution system of this embodiment makes it possible to enhance an FEC process's capability of reconstructing streaming data, to improve quality of receiving the streaming data, and to reproduce the streaming data in a stable manner. That is because the receiver apparatus 30 is configured to re-transmit streaming data on which the FEC process is determined to be unable to be performed, only in a case where the re-transmission process of the data is going to be completed before the FEC process resumes or before a reproduction process starts.

According to the streaming data distribution system of this embodiment, since it is possible to avoid the situation of reproducing the received streaming data having many errors directly in the case where it is impossible to perform an FEC process on the received streaming data, the received streaming data can be reproduced with high quality.

According to the streaming data distribution system of this embodiment, since it is possible to reconstruct the streaming data as much as possible, by re-transmitting the streaming data in the case where the time when the re-transmission process of the streaming data is estimated to be completed is not going to be earlier than the time when the FEC process of the streaming data is estimated to be started and the time when the re-transmission process of the streaming data is estimated to be completed is going to be earlier than the time when the reproduction process of the streaming data is estimated to be started, the received streaming data can be reproduced with high quality.

(Modification)

The re-transmission method in the streaming data distribution system of above mentioned first embodiment can be modified as follows.

First, the data transmitter section 36 of the receiver apparatus 30 is configured to insert, into a re-transmission request to be transmitted to the distribution server 10, information showing whether the re-transmission request is the first re-transmission request or the second re-transmission request.

Second, the data transmitter section 12 of the distribution server 10 is configured to add, to streaming data to be transmitted, a flag which is used to determine that the streaming data is normal streaming data or the streaming data is streaming data which has been re-transmitted in response to a re-transmission request sent from the receiver apparatus 30, based on the information inserted into the re-transmission request received by the data receiver section 13.

Third, the data processor section 35 of the receiver apparatus 30 is configured to determine that the streaming data is normal streaming data or the streaming data is streaming data which has been re-transmitted in response to a re-transmission request (the first or the second re-transmission request) sent from the receiver apparatus 30, based on the flag added to the streaming data received from the distribution server 10.

(Streaming Data Distribution System According to Second Embodiment of Present Invention)

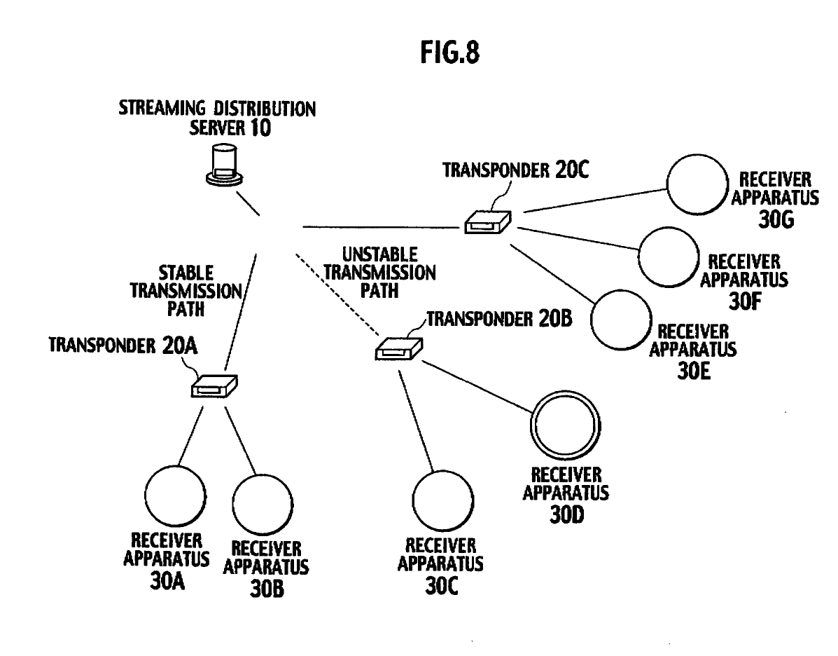

By referring to FIG. 8, descriptions will be provided for a streaming data distribution system according to a second embodiment of the present invention.

In the streaming data distribution system according to this embodiment, the distribution server 10 is configured to transmit streaming data to a plurality of receiver apparatuses 30A to 30G via a network including a plurality of transponders 20A to 20C by multicast distribution method.

Basically, since functions of the receiver apparatus 30 in the streaming data distribution system according to this embodiment are same as functions of the receiver apparatus 30 in the streaming data distribution system according to the first embodiment, description will be provided by focusing on the difference between both of the receiver apparatuses 30.

In the case where the RMTP (Reliable Multicast Transport Protocol) method is used, the data transmitter section 36 of the receiver apparatuses 30D is configured to send the first and second re-transmission request to a representative terminal of a group in the RMTP method (for example, transponder 20B) by unicast distribution method.

In this case, the transponder 20B re-transmits streaming data to the receiver apparatus 30D, when holding the streaming data corresponding to the first or second re-transmission request received from the receiver apparatus 30D.

On the other hand, the transponder 20B transfers the first or second re-transmission request received from the receiver apparatus 30D to distribution server 10 in upstream direction, when not holding the streaming data corresponding to the first or second re-transmission request received from the receiver apparatus 30D.

In the case where the SRM (Scalable Reliable Multicast) method is used, the data transmitter section 36 of the receiver apparatuses 30D is configured to send the first and second re-transmission request by multicast distribution method.

In this case, a terminal which receives the first or second re-transmission request sent by the receiver apparatus 30D and holds the streaming data corresponding to the first or second re-transmission request (for example, receiver apparatus 30C, transponder 20B or the like) re-transmits streaming data to the receiver apparatus 30D.

According to the streaming data distribution system of this embodiment, in the case where the streaming data is distributed by multicast distribution method, it possible to enhance capability of reconstructing streaming data through an error correction process, to improve quality of receiving the streaming data, and to reproduce the streaming data in a stable manner.

The present invention can provide a receiver apparatus which makes it possible to enhance capability of reconstructing streaming data through an error correction process, to improve quality of receiving the streaming data, and to reproduce the streaming data in a stable manner.

Additional advantages and modifications will readily occur to those skilled in the art. Therefore, the invention in its broader aspects is not limited to the specific details and the representative embodiments shown and described herein. Accordingly, various modifications may be made without departing from the scope of the general inventive concept as defined by the appended claims and their equivalents.

What is claimed is:

1. A receiver apparatus which receives streaming data transmitted from a distribution server via a network, comprising:
a comparison section configured to compare a time when a re-transmission process of the received streaming data is estimated to be completed with a time when an error correction process of the received streaming data is estimated to be started, when the error correction process can not be applied to the streaming data; and
a re-transmission request section configured to send the distribution server a first re-transmission request for requesting that the streaming data be re-transmitted, when it is determined that the time when the re-transmission process is estimated to be completed is going to be earlier than the time when the error correction process is estimated to be started.

2. The receiver apparatus according to claim 1, wherein
the comparison section is configured to compare the time when the re-transmission process is estimated to be completed with a time when a reproduction process of the streaming data is estimated to be started, when it is determined that the time when the re-transmission process is estimated to be completed is not going to be earlier than the time when the error correction process is estimated to be started,
the re-transmission request section is configured to send the distribution server a second re-transmission request for requesting that the streaming data be re-transmitted, when it is determined that the time when the re-transmission process is estimated to be completed is going to be earlier than the time when the reproduction process is estimated to be started, and
the receiver apparatus further comprises a data processor section configured to control to reproduce the streaming data re-transmitted in response to the second re-transmission request without performing the error correction process on the steaming data.

3. A method for distributing streaming data from a distribution server to a receiver apparatus via a network, comprising:
comparing, at the receiver apparatus, a time when a re-transmission process of the received streaming data is estimated to be completed with a time when an error correction process of the received streaming data is estimated to be started, when the error correction process can not be applied to the streaming data; and
sending, at the receiver apparatus, the distribution server a first re-transmission request for requesting that the streaming data be re-transmitted, when it is determined that the time when the re-transmission process is estimated to be completed is going to be earlier than the time when the error correction process is estimated to be started.

4. The method according to claim 3, wherein
in the comparing step, the receiver apparatus compares the time when the re-transmission process is estimated to be completed with a time when a reproduction process of the streaming data is estimated to be started, when it is determined that the time when the re-transmission process is estimated to be completed is not going to be earlier than the time when the error correction process is estimated to be started,
in the sending step, the receiver apparatus sends the distribution server a second re-transmission request for requesting that the streaming data be re-transmitted, when it is determined that the time when the re-transmission process is estimated to be completed is going to be earlier than the time when the reproduction process is estimated to be started, and
the method further comprises controlling, at the receiver apparatus, to reproduce the streaming data re-transmitted in response to the second re-transmission request without performing the error correction process on the steaming data.
